(19) United States
(12) Patent Application Publication
(10) Pub. No.: US 2010/0077076 A1
(43) Pub. Date: Mar. 25, 2010

(54) MANAGEMENT APPARATUS AND METHOD THEREOF

(75) Inventor: Katsuhiro Wada, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/443,952

(22) PCT Filed: Nov. 21, 2007
(86) PCT No.: PCT/JP2007/072990

§ 371 Date: Apr. 1, 2009

(30) Foreign Application Priority Data
Nov. 30, 2006 (JP) 2006-324696

(51) Int. Cl. G06F 15/16

(52) U.S. Cl. 709/224; 709/223

(57) ABSTRACT

A management apparatus determines whether or not another management apparatus exists on a network, and if it is determined that the another management apparatus exists, acquires information on a device searched by the another management apparatus from the another management apparatus. The management apparatus searches a device on the network and determines whether or not the searched device is searched by the another management apparatus, and acquires information from the device, that is not acquired among information on the device, in a case that it is determined that the device is not searched by the another management apparatus.

### TECHNICAL FIELD

The present invention relates to a management processing technique of a network device using a plurality of distributed management agents.

### BACKGROUND ART

Conventionally, there has been a method using a Simple Network Management Protocol/Management Information Base (SNMP/MIB) as a method for managing a network device, which is a device connected to a computer network.

According to the SNMP network management technique, a network management system includes at least one network management station (NMS), several managed nodes, each of which contains an agent, and a network management protocol, which is used by a management station or an agent to transmit or receive management information. A user can use network management software via the NMS to communicate with agent software on the managed nodes. Thereby, the user can acquire data on a network or change the data.

When such network management software is used in a distributed environment, the network management software generally includes a server application and a client application. The server application has a network management function. The client application is a graphical user interface (GUI), which is activated at a terminal.

Between different terminals in such a distributed environment, the client application and the server application execute interprocess communication. Request For Comments (RFC) 1057 Remote Procedure Call (RPC) is defined as a standard of interprocess communication. In RPC, a server stores a group of functions to provide a network service, and a client process of a terminal on the network can call up a function from among the group of functions similar to a function stored in a local machine.

The flow of interprocess communication in RPC is conducted as follows. A client calls an RPC function stored in a server as a service request to the server. At this point in time, a data packet storing call information on the function is transmitted to the server. The program (process) of the client is suspended. When the server receives the packet, the server dispatches the called function. The server extracts an argument of the function. Then, the server executes a service based on the argument. The server transmits a result of the function to the client. After the client receives the result of the function, the client resumes execution of the program (process).

A single server application having the above-described network management function is placed on a distributed network. The server application includes a plurality of instances to manage a plurality of devices. On the other hand, a plurality of client applications run at respective different terminals and can access the server application using the above-described interprocess communication. Each client application can execute acquisition and setting of device information via the server application.

Further, the server application also provides a client with a device search function to search for a network device as the network management function. Thus, the client can acquire basic device information, such as an address and name, of a device which the client intends to manage from a device list searched by the server application.

FIG. 1 is a diagram illustrating an example of a configuration of a computer network which can be managed via a network.

In the computer network illustrated in FIG. 1, three local area networks (LANs) 100, 110 and 120 are mutually connected by routers 130 and 140, respectively. Further, a personal computer (PC) 103 as a client, a network printer 122 as a managed node, and communication devices 104 and 121 as network management stations (servers) are respectively connected to the LANs 100, 110 and 120.

FIG. 2 depicts a schematic view illustrating a case where the PC 103 connected to the LAN 100 operates as a client and the communication device 121 connected to the LAN 120 operates as a server device. In FIG. 2, “DEVICE” refers to a network device connected to a LAN and includes a network printer, a computer, or the like.

In FIG. 2, a process A of a client application on the PC 103 accesses a process B of a server application on the communication device 121 to instruct the process B to search for a device. In this case, the client application (process A) communicates with the server application (process B) using the function of the interprocess communication. Here, the server application uses SNMP broadcast to execute the device search.

The device search is executed with two steps. The first step acquires address information of each device via broadcasting. The second step acquires a management information base (MIB) value of basic device information, such as a device name and a location, with respect to each device found via broadcasting.

In order to execute a device search, each client application executes interprocess communication using a proxy to request the server application to execute the device search. The server application receives information transmitted from the proxy (stub) and executes the device search using SNMP broadcast. In the default setting, the server application searches only for devices which exist on a sub network where the server application exists. Here, the sub network refers to an area of a network sectioned by a router on the network. In the example in FIG. 1, each of the LAN 100, 110 and 120 corresponds to the sub network. If the client application designates a search range across a sub network, for example if the client application designates execution of a device search on the LAN 120 in FIG. 2, the server application searches for a device by executing sub network broadcast.

Further, a Service Location Protocol (SLP) and a Web Services Dynamic Discovery Protocol can generally execute a device search across a router using a multicast protocol. Device list information obtained from a search result is transmitted from the stub of the server application to the proxy using interprocess communication. The device list information is notified as a callback from the proxy to the client application. The client application executes bitmap display based on the callback information from the server application to display the device list information.

In such a system, a device search service sometimes cannot use a sub network broadcast search due to a limited function of a network device, such as a router. Further, a search service module is distributed and placed for each sub network for the reason that a multicast search cannot be used due to the specification of a device (see Japanese Patent Application Laid-Open No. 2003-99341).

In the above-described example, it may be necessary to prepare a search service module for each sub network. Accordingly, it may be necessary to manage the configuration of a network (sub network configuration) and the location of a search service on the network.

Further, when a plurality of servers are placed on the same sub network, if a search instruction is supplied to the plurality of servers, a large number of broadcast packets are generated on the sub network, thus increasing traffic. On the other hand, when only a specific server representatively searches the sub network in order not to increase traffic, a long time may be required for the search to be completed. Thus, an increase in the speed of search with the distributed servers cannot be expected. Furthermore, if a search broker has an upper limit of the number of searches, a large-scale network in which a large number of devices exist in a specific node cannot be supported. Further, there is a higher possibility of an incomplete search result in a case where only a single server operates compared to a case where a plurality of servers operate.

Further, in a case where a multicast packet is used to search devices on a LAN distant in the number of hops, the multicast packet sometimes cannot be used depending on the specification of a device. Therefore, a client needs to know LAN information in advance, such as an address of a managed sub network, and, thus, a network management system capable of efficiently managing agents cannot be configured.

### DISCLOSURE OF INVENTION

It is an object of the present invention to eliminate the above-described problems of the conventional technology.

According to an aspect of the present invention, there is provided a management apparatus includes a first determination unit configured to determine whether or not another management apparatus exists on a network, a first acquisition unit configured to acquire information on a device searched by the another management apparatus from the another management apparatus, in a case that it is determined by the first determination unit that the another management apparatus exists on the network, a search unit configured to search for a device on the network, a second determination unit configured to determine whether or not the device searched by the search unit is searched by the another management apparatus based on information on the device searched by the search unit and the information acquired by the first acquisition unit, and a second acquisition unit configured to acquire information from the device, that is not acquired by the search unit from among information on the device searched by the searched unit, in a case that it is not determined by the second determination unit that the device searched by the search unit is searched by the another management apparatus.

According to another aspect of the present invention, there is provided a method includes the steps of judging whether or not another management apparatus exists on a network, acquiring information on a device searched by the another management apparatus from the another management apparatus, in a case that it is judged in the judging step that the another management apparatus exists on the network, searching for a device on the network, determining whether or not the device searched is searched by the another management apparatus based on information on the device searched in the searching step and the information acquired in the acquiring step, and obtaining information from the device, that is not acquired in the searching step from among information on the device, in a case that it is not determined in the determining step that the device searched in the searching step is searched by the other management apparatus.

Further features and aspects of the present invention will become apparent from the following detailed description of exemplary embodiments with reference to the attached drawings.

### BRIEF DESCRIPTION OF DRAWINGS

The accompanying drawings, which are incorporated in and constitute a part of the specification, illustrate exemplary embodiments, features, and aspects of the invention and, together with the description, serve to explain the principles of the invention.

FIG. 1 is a diagram illustrating an exemplary configuration of a computer network which can be managed via a network.

FIG. 2 depicts a schematic view illustrating a case where a computer device (PC) operates as a client and a communication device operates as a server device.

FIG. 3 is a diagram illustrating a configuration of a network device distributed management system according to a first exemplary embodiment of the present invention.

FIG. 4 is a diagram illustrating an exemplary configuration of a case where a client, a plurality of servers, and at least one agent exist on a network in the network device distributed management system according to the first exemplary embodiment of the present invention.

FIG. 5 is a block diagram illustrating a configuration of a server according to an exemplary embodiment of the present invention.

FIG. 6 is a flowchart illustrating processing when a server executes a device search in the network device distributed management system according to the first exemplary embodiment of the present invention.

FIG. 7 is a diagram illustrating an example of server management information that is managed by an other-server management unit according to an exemplary embodiment of the present invention.

FIG. 8 is a diagram illustrating an example of a result of a main search according to the first exemplary embodiment of the present invention.

FIG. 9 is a diagram illustrating an example of a result of a sub search according to the first exemplary embodiment of the present invention.

FIG. 10 is a flowchart illustrating processing when a server executes a device search in a network device distributed management system according to a second exemplary embodiment of the present invention.

FIG. 11 is a diagram illustrating an example of a search result according to the second exemplary embodiment of the present invention.

FIG. 12 is a flowchart illustrating processing when a server executes a device search in a network device distributed management system according to a third exemplary embodiment of the present invention.

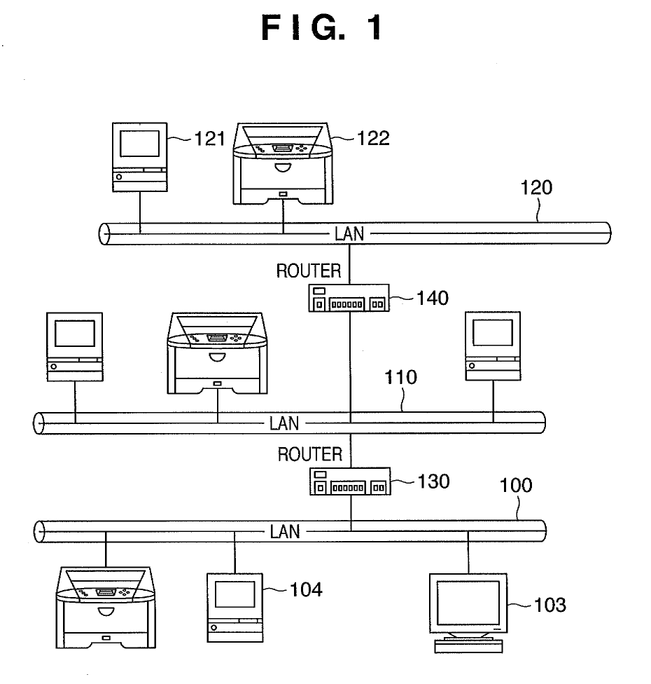

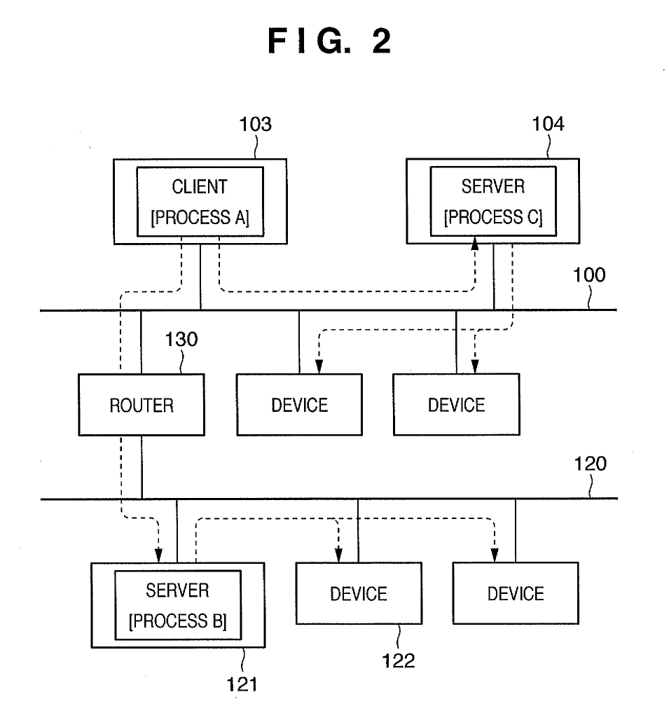

### BEST MODE FOR CARRYING OUT THE INVENTION

Embodiments of the present invention will now be described in detail with reference to the accompanying drawings. The following embodiments are not intended to limit the claims of the present invention, and not all combinations of features described in the embodiments are essential for the present invention.

### First Exemplary Embodiment

First, a network device distributed management system according to a first exemplary embodiment of the present invention will be described.

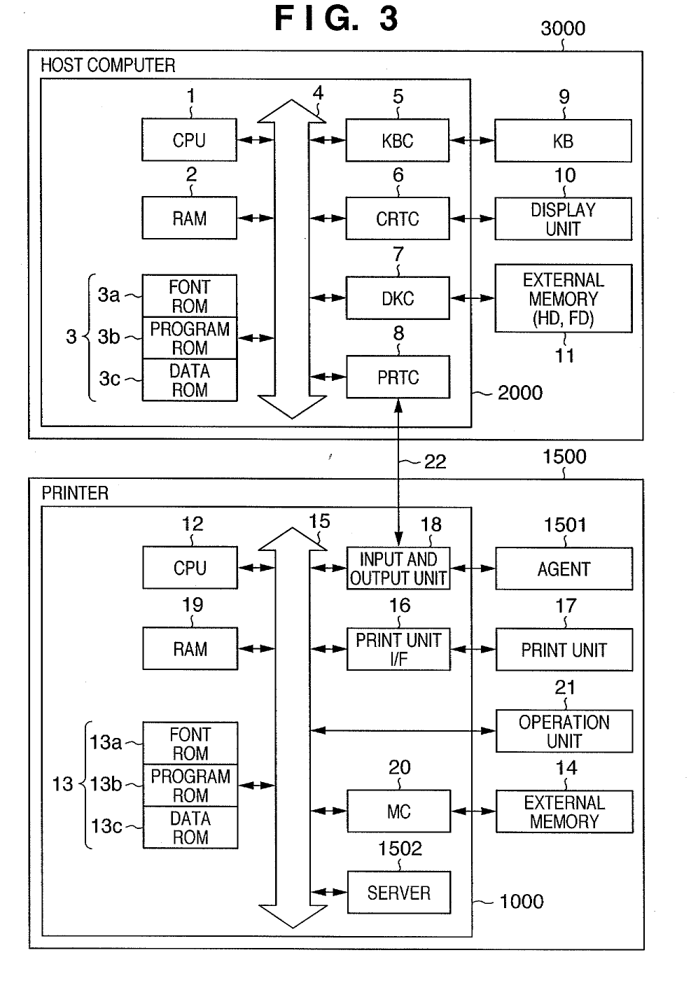

FIG. 3 is a diagram illustrating a configuration of a network device distributed management system according to the first exemplary embodiment of the present invention. The network device distributed management system includes a host computer 3000, serving as an information processing apparatus, and a printer 1500, serving as a management apparatus and a device. However, the network device distributed management system can further include a network device connected thereto. For example, the network device distributed management system can include a printer as merely a device that does not have a function as a management apparatus. In the network device distributed management system according to an exemplary embodiment, a central processing unit (CPU) 12, a random access memory (RAM) 19, and a read only memory (ROM) 13 of the printer 1500 can execute such a network device distributed management process as that implemented by the program of the host computer 3000.

Further, an embodiment of the present invention can also be applied to a case where a connection between the host computer 3000 and the printer 1500 is made via a network other than a LAN or a wide area network (WAN).

An agent of a managed device, which will be described below in the first exemplary embodiment, corresponds to an input and output unit 18. The input and output unit 18 serves as a network interface of the printer 1500. A client that manages the agent corresponds to the host computer 3000.

A server section (herein after, abbreviated as “server”) 1502 collects information from the agent. The server 1502 can provide a client with information.

The server 1502 can operate as a program in an Embedded Java® environment. Further, the server 1502 can also operate as a program in an Embedded Java® environment, which runs with the CPU 12, the RAM 19, and the ROM 13 of the printer 1500. In the present exemplary embodiment, the program of the server 1502 runs on the printer 1500. However, the program of the server 1502 can also run on a PC connected to a network.

A configuration of the host computer 3000 is described first. A CPU 1 executes centralized control of each device connected to a system bus 4. The CPU 1 executes various types of processing, such as document processing, based on an application (e.g., document processing program) stored in a program ROM 3b of a ROM 3 or an external memory 11. The document processing includes processing graphics, images, characters, tables (i.e., spreadsheets), and others. Further, the CPU 1 executes rasterization processing of outline font to a display RAM set on a RAM 2 to provide a display on a display unit 10 via a CRTC (display control unit) 6. Furthermore, the CPU 1 opens various registered windows based on a command designated with a mouse cursor (not illustrated) on the display unit 10 to execute various types of data processing. In a case that a user intends to print a document using the printer 1500, the user can open a window for print setting and set a print processing method to a printer driver including the setting of the printer 1500 and the selection of a print mode. The display unit 10 is not limited to a cathode-ray tube (CRT). The display unit 10 can also be a liquid crystal or plasma display.

The RAM 2 functions as a main memory and a work area of the CPU 1. The ROM 3 includes a font ROM 3a, a program ROM 3b, and a data ROM 3c. The font ROM 3a or the external memory 11 stores font data that is used when the above-described document processing is executed. The program ROM 3b or the external memory 11 stores an operating system (OS), which is a control program of the CPU 1. The data ROM 3c or the external memory 11 stores various data when the above-described document processing is executed. Also, a program stored in the external memory 11 is loaded into the RAM 2 during execution and is executed.

A keyboard controller (KBC) 5 controls inputting information from a keyboard (KB) 9 or a pointing device (not illustrated). The CRTC 6 controls display on the display unit 10. A disk controller (DKC) 7 controls access to the external memory 11. A printer controller (PRTC) 8 is connected to the printer 1500 via a bidirectional interface 22. The PRTC 8 executes communication control processing with the printer 1500. The KB 9 includes various keys. The display unit 10 displays graphics, images, characters, tables, and others. The external memory 11 includes a hard disk (HD) or a floppy disk (FD). The external memory 11 stores boot programs, various applications, font data, user files, edit files, a printer control command generation program (hereinafter referred to as a printer driver), and others.

The above-described CPU 1, RAM 2, ROM 3, KBC 5, CRTC 6, DKC 7, and PRTC 8 are disposed on a computer control unit 2000.

A configuration of each part of the printer 1500 is described next. The CPU 12 executes centralized control of each device connected to a system bus 15. The CPU 12 outputs an image signal as print information to a print unit (printer engine) 17 based on a control program stored in a program ROM 13b of the ROM 13 or a control program stored in an external memory 14. Further, the CPU12 can execute communication processing with the host computer 3000 via the input and output unit 18 to allow information in the printer 1500 to be notified to the host computer 3000.

The RAM 19 is configured to function as a main memory and a work area of the CPU 12 and to allow a memory capacity to be extended by connecting an optional RAM (not illustrated) to an extension port. The RAM 19 is used as an output information loading area, an environmental data storing area, and a nonvolatile random access memory (NVRAM). The ROM 13 includes a font ROM 13a, the program ROM 13b, and a data ROM 13c. The font ROM 13a stores font data that is used when the above-described print information is generated. The program ROM 13b stores a control program of the CPU 12. The data ROM 13c stores information that is used on the host computer 3000 when the external memory 14, such as a hard disk, is not connected to the printer 1500.

The input and output unit 18, such as a network card, executes transmission and receiving of data between the printer 1500 and the host computer 3000 via the bidirectional interface 22. Further, an agent section (hereinafter, abbreviated as “agent”) 1501 connected to the input and output unit 18 communicates with the host computer 3000 or the server 1502 via the bidirectional interface 22 or the system bus 15. In the present exemplary embodiment, the server 1502 is connected to the system bus 15. The agent 1501 is connected to the input and output unit 18. However, the agent 1501 can operate on the CPU 12, the RAM 19, and the ROM 13 of the printer 1500.

A print unit interface (I/F) 16 executes transmission and receiving of data between the CPU 12 and the print unit 17. A memory controller (MC) 20 controls access to the external memory 14. The print unit 17 performs a printing operation based on the control of the CPU 12. An operation unit 21 includes switches for various operations and display units (e.g., an LCD and a light-emitting diode (LED) display). The external memory 14 includes an HD, an integrated circuit (IC) card, and others. The external memory 14 is optionally connected to the printer 1500. The external memory 14 stores font data, emulation programs, form data, and others. The MC 20 controls access to the external memory 14. The external memory 14 is not limited to one. A plurality of external memories 14 can be included. That is, a plurality of external memories can be included storing internal font, an option card, and a program for interpreting a printer control language having a different language system. Further, a nonvolatile random access memory (NVRAM) (not illustrated) can be included to store printer mode setting information input using the operation unit 21.

The above-described CPU 12, RAM 19, ROM 13, input and output unit 18, print unit I/F 16, and MC 20 are disposed on a printer control unit 1000.

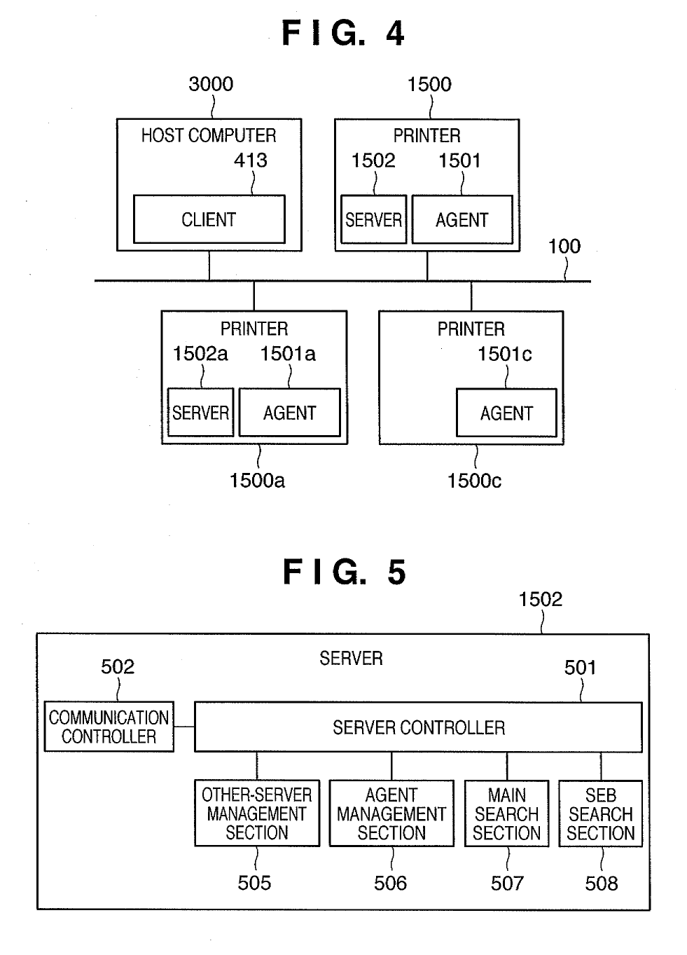

FIG. 4 is a diagram illustrating an exemplary configuration of a case where a client, a plurality of servers, and at least one agent (a device to be managed) exist on a network in the network device distributed management system according to the first exemplary embodiment of the present invention.

On the host computer 3000, a client 413, which is a management software for a network device, is activated. On the printer 1500 connected to the host computer 3000 via the LAN 100, the agent 1501 is activated. The agent 1501 generates information on the state and configuration of the printer 1500, which is notified to the client 413. Further, the server 1502 is activated. The server 1502 causes an agent in the sub network (the LAN 100) to execute a command from the client 413.

Also, on another printer 1500a, which is connected to the LAN 100, an agent 1501a and a server 1502a are activated. Further, on another printer 1500c, which is connected to the LAN 100, an agent 1501c is activated. As described above, in the configuration illustrated in FIG. 4, two servers, the server 1502 and the server 1502a, exist on the LAN 100.

FIG. 5 is a block diagram illustrating a configuration of the server 1502 of the printer 1500 according to the present exemplary embodiment.

A server controller 501 controls the server 1502. A communication controller 502 executes communication control between the client 413 and the server 1502 and between the server 1502a and the server 1502. The communication controller 502 further executes communication control between the server 1502 and the managed agent 1501. Each of these communications executes the server function and the client function of a web service, and an SNMP and an SLP for device management depending on a type of use for communication. An other-server management section 505 stores a result of a search in a server service with a multicast packet and information on managed agents searched for. An agent management section 506 stores agent information on a result of search execution. When the agent management section 506 receives a search instruction or an agent acquisition instruction from a client or another server, the agent management section 506 notifies the client or another server of the agent information managed by the server 1500. A main search section 507 executes a search to confirm the existence of devices on the network 100. For example, the main search section 507 searches for an address of a service, such as Probe of WS-Discovery or Probe Match Packet. A sub search section 508 acquires configuration information and statuses of the devices based on the address search result obtained by the main search section 507, which are required by a client.

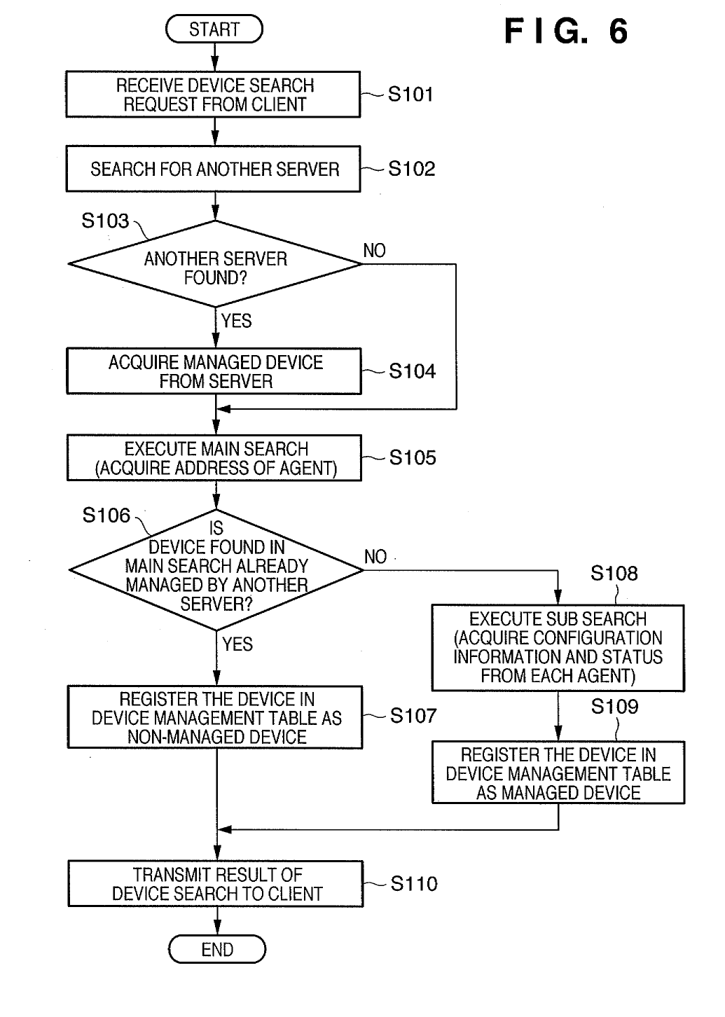

FIG. 6 is a flowchart illustrating processing in a case that the server 1502 executes a device search in the network device distributed management system having the above-described configuration.

In step S101, the server 1502 receives a device search request from the client 413 after the server 1502 starts services. Then, the processing proceeds to step S102, in which the other-server management section 505 confirms whether or not another server exists.

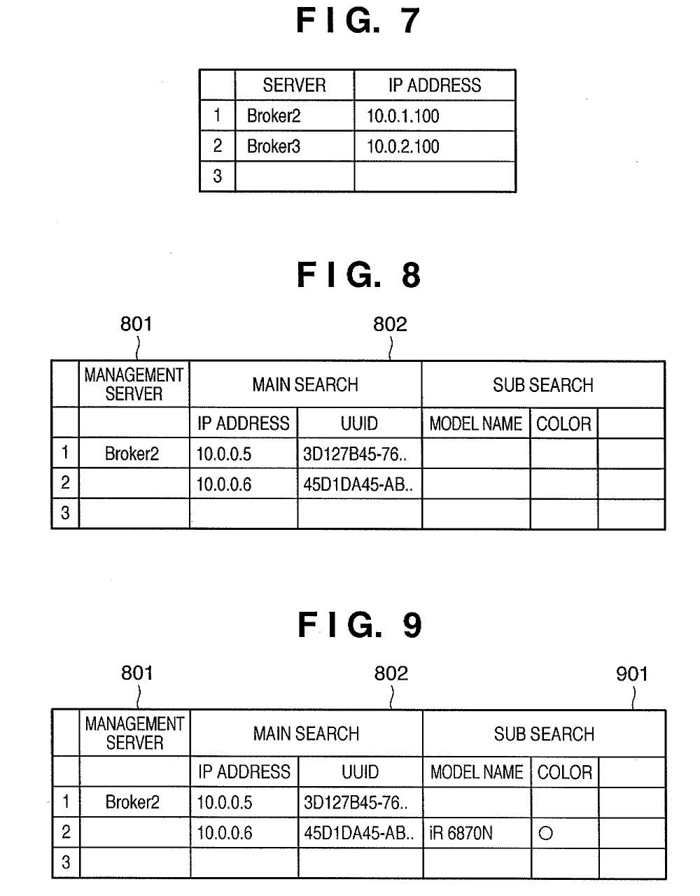

FIG. 7 is a diagram illustrating an example of server management information that is managed by the other-server management section 505 according to the present exemplary embodiment.

In the server management information, an Internet Protocol (IP) address is registered corresponding to each server searched for.

As a method of searching for a server, there is a method of registering the addresses of other servers on the LAN 100 beforehand. Further, methods are considered in which a server is searched for according to an SLP by a broadcast address, a multicast address or the like, and the existence of a server is confirmed according to an original protocol fixed with a port number.

When servers are searched for in step S102, another server is searched for with a hop count larger than that of a search scheduled in a device search request. Thus, cases where agents are repeatedly searched can be decreased. In step S103, the server 1502 determines whether or not another server is found based on a result of the search in step S102. If another server is found (YES in step S103), the processing proceeds to step S104, in which the server 1502 acquires a list of agents that have already been managed by another server. Then, the processing proceeds to step S105. The agent management section 506 stores such information as agent information managed by another server. If another server is not found (NO in step S103), the processing proceeds to step S105.

In step S105, the server 1502 executes a main search to acquire the addresses of agents. The main search includes, for example, Probe of WS-Discovery. Thus, a device satisfying a search condition transmits a Probe Match packet to the server 1502. Thus, a device identifier, such as a Universally Unique Identifier (UUID), can be obtained as the address of the device. The agent management section 506 stores such information as a result of the main search.

FIG. 8 is a diagram illustrating an example of a result of the main search.

In FIG. 8, a column 801 stores the name of a management server. A column 802 stores the IP address and UUID of a device as a result of the main search. That is, in the example in FIG. 8, a server “Broker2” manages a device having an IP address of “10.0.0.5” found as a result of the main search.

In step S106, the server 1502 compares a device which is stored by the agent management section 506 and found in the main search with a device (agent) which is stored by the agent management section 506 and managed by another server. If a device which is already managed by another server exists among all of the devices found in the main search (YES in step S106), the processing proceeds to step S107. In step S107, the server 1502 registers the device in a device management table of the agent management section 506 as a non-managed device.

On the other hand, if a device found in the main search is an agent which is not managed by another server (NO in step S106), the processing proceeds to step S108. In step S108, the server 1502 executes a sub search to acquire configuration information and a status from the agent. The sub search acquires information required by the client 413 based on the result of the main search. For example, the sub search acquires the model name of the device, the connection state of peripheral devices as configuration information, a device status and peripheral device status, various logs, and the setting of the device. In step S109, the server 1502 registers the device in the device management table as a managed device.

FIG. 9 is a diagram illustrating an example of a result of the sub search.

As apparent from a comparison between FIGS. 8 and 9, a column 901, indicating a result of the sub search, stores the model name of a device corresponding to the IP address of “10.0.0.6” and the indication that the model can perform color printing.

After step S107 or step S109 is complete, the processing proceeds to step S110. In step S110, the server 1502 transmits a result of the device search to the client 413.

Alternatively, in step S103, if a large number of servers are found, traffic may be excessively increased due to the communication between servers. Accordingly, in such cases, the server 1502 can prompt a user to relocate servers via the client 413. Alternatively, a user can also stop unnecessary servers.

According to the above-described first exemplary embodiment, even if a plurality of servers exist, a communication in which a plurality of servers and a client acquire duplicate information can be prevented or reduced. Thus, an agent management which is small in traffic of a network and is efficient can be performed.

Furthermore, a server can be prevented from using a useless resource with respect to a managed device. Furthermore, a user is allowed to execute an efficient device management without concern for the location of servers.

### Second Exemplary Embodiment

In the above-described first exemplary embodiment, if an agent found in the main search is not managed by another server, the current server executes a sub search to manage the agent for itself. Further, in a second exemplary embodiment, when the server executes the sub search, the server can adopt an attribute having a fixed value, such as a model name, the value of which is not changed every time the sub search is executed, and thus does not reacquire the attribute if the acquired information is already stored. Accordingly, the server can further reduce network traffic.

Thus, the second exemplary embodiment of the present invention provides a network device distributed management system to efficiently manage network devices in such an environment.

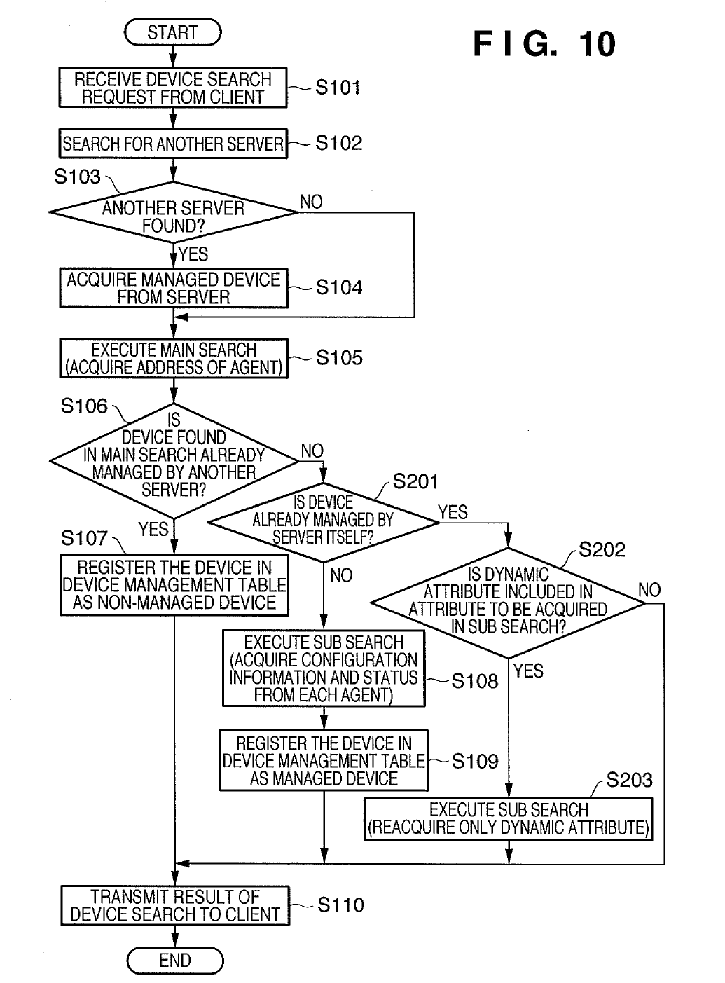

FIG. 10 is a flowchart illustrating processing in a case that a server executes a device search in the network device distributed management system according to the second exemplary embodiment. The configuration of the network device distributed management system according to the second exemplary embodiment is similar to that of the above-described first exemplary embodiment. Therefore, the description thereof will not be repeated. In FIG. 10, steps S101 through S110 are similar to steps S101 to S110 in the flowchart in FIG. 6. Thus, the description thereof will not be repeated.

If a plurality of servers exist on a sub network, in step S106, the server 1502 confirms whether or not an agent is already managed by another server. If a non-managed device exists (NO in step S106), the processing proceeds to step S201, in which the server 1502 confirms whether or not the device is managed by the server 1502 itself. If the device is managed by the server 1502 itself (YES in step S201), the processing proceeds to step S202. In step S202, the server 1502 confirms whether or not an attribute to be acquired in a sub search includes a dynamic attribute. If a dynamic attribute does not exist (NO in step S202), the server 1502 does not execute a sub search, and the processing proceeds to step S110. In step S110, the server 1502 notifies the client 413 of a result of the device search. On the other hand, if a dynamic attribute is included (YES in step S202), the processing proceeds to step S203. In step S203, the server 1502 executes a sub search to reacquire only the dynamic attribute. Then, the processing proceeds to step S110, in which the server 1502 completes the sub search to notify the client 413 of a result of the sub search.

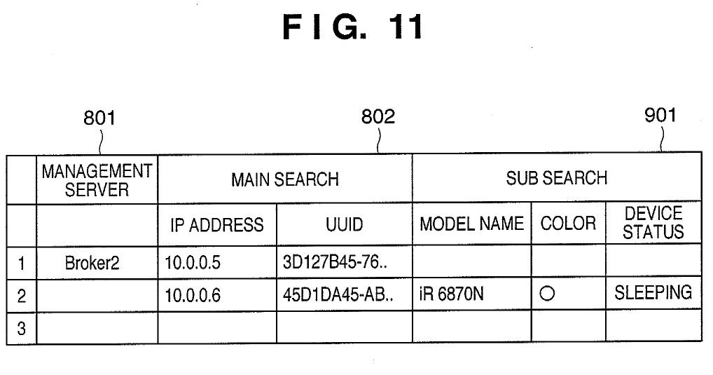

FIG. 11 is a diagram illustrating an example of a result of a device search according to the second exemplary embodiment of the present invention.

In FIG. 11, a device having an IP address of “10.0.0.6” is managed by the server 1502 itself and a sub search thereof is already complete. In this case, if the server 1502 receives a search instruction again, since attributes indicating a model name and capability of color printing have a fixed value, the server 1502 does not reacquire such attributes. However, as illustrated in a column 901, since a device status (for example, sleeping) is a dynamic attribute, the server 1502 reacquires the attribute. In the present exemplary embodiment, whether each attribute is a static attribute or a dynamic attribute is set for each attribute beforehand.

As described above, according to the second exemplary embodiment, even in a case where a plurality of servers exist, the servers and the client do not perform communication to acquire duplicate information. Thus, an efficient agent management with less traffic can be performed.

Further, since servers do not acquire duplicate attributes, information acquisition with less traffic can be performed. In addition, a server can be prevented from using a useless resource with respect to a managed device.

Furthermore, a user is allowed to execute efficient device management without concern for the location of servers.

### Third Exemplary Embodiment

In the above-described first exemplary embodiment, if an agent found in the main search is not managed by another server, the server 1502 executes a sub search to manage the agent by the server 1502 itself. However, in a case that an agent that is not managed by any server exists, if the client 413 instructs the server 1502 to execute a device search using multicast, a plurality of servers may simultaneously execute the sub search.

Therefore, in a third exemplary embodiment of the present invention, the server 1502 confirms whether or not a device is managed by another server and executes reservation for execution of the sub search on other servers. The server 1502 executes the sub search after the server 1502 completes the reservation to other servers. Further, if the sub search is not actually executed after the reservation for the sub search is completed, the reservation for executing the sub search is disabled after a predetermined period of time.

The third exemplary embodiment is directed to a network device distributed management system capable of efficiently managing a network device in such an environment.

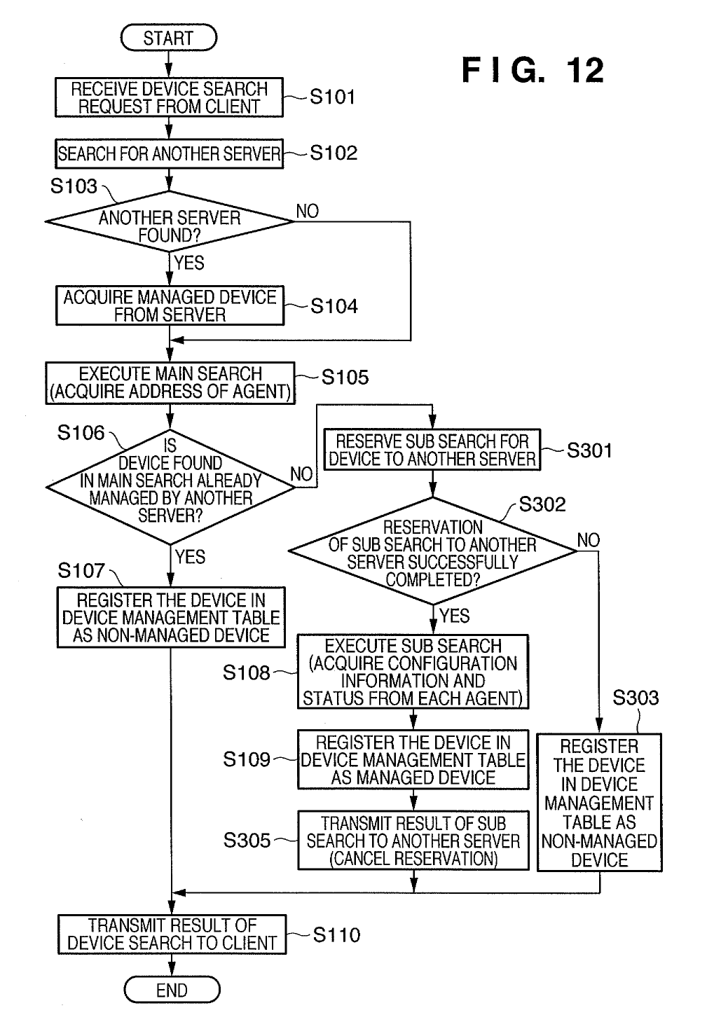

FIG. 12 is a flowchart illustrating processing in a case that a server executes a device search in the network device distributed management system according to the third exemplary embodiment. A configuration of the network device distributed management system according to the third exemplary embodiment is similar to that of the above-described first exemplary embodiment. Therefore, the description thereof will not be repeated.

In FIG. 12, steps S101 to S110 are similar to steps S101 to S110 in the flowchart in FIG. 6. Thus, the description thereof will not be repeated.

If a plurality of servers exist on a sub network, in step S106, the server 1502 confirms whether or not an agent is already managed by any one of other servers. If a device which is not managed by another server exists (NO in step S106), the processing proceeds to step S301. In step S301, the server 1502 executes reservation for a sub search for a device to other servers. Then, the processing proceeds to step S302, in which the server 1502 confirms whether or not the reservation for the sub search to other servers is successfully completed. If the reservation for the sub search to other servers is successfully completed (YES in step S302), the processing proceeds to step S108. In step S108, the server 1502 executes the sub search to acquire configuration information and a status from an agent. In step S109, the server 1502 acquires information required by the client 413 and servers for a search based on a result of the main search. The server 1502 registers the device in the device management table as a managed device. Subsequently, the processing proceeds to step S305. In step S305, the server 1502 notifies the other servers of a result of the sub search and cancel the reservation. However, even if this notification is not executed, other servers can execute a sub search after a predetermined period of time has passed from the reservation for the sub search. Alternatively, even when the cancellation of the reservation is not notified due to a reason that the server having executed the reservation fails in a sub search, another server can execute a sub search if a further server does not manage the agent.

On the other hand, in step S302, if the reservation for a sub search to other servers is not successful, that is, if another server already manages the device (NO in step S302), the processing proceeds to step S303. In step S303, the server 1502 registers the device in the device management table as a non-managed device. Then, the processing proceeds to step S110.

As described above, according to the third exemplary embodiment, even if a plurality of servers exist, a communication in which a plurality of servers and a client acquire duplicate information can be prevented or reduced. Thus, an agent management which is small in traffic of a network and is efficient can be performed.

Further, since the server does not acquire duplicated attributes, it is possible to execute information acquisition having smaller traffic.

Furthermore, a server can be prevented from using a useless resource with respect to a managed device. Furthermore, a user is allowed to execute efficient device management without concern for the location of servers.

### Other Exemplary Embodiments

The present invention can be achieved by providing a system or an apparatus with a software program realizing functions of the above-described exemplary embodiments directly or remotely, and reading and executing the provided program by a computer of the system or apparatus. In such a case, the program can have any form as long as it has a function of a program.

Accordingly, in order to realize the processing of the functions of the exemplary embodiments by a computer, program code itself installed in the computer realizes the present invention. That is, the present invention includes a computer program itself to realize the processing of the function of the exemplary embodiments. In such a case, the program can be in any form, such as object code, a program to be executed by an interpreter, and script data to be supplied to an operating system (OS), as long as it has a function of a program.

Various recording media for providing a program can be used. For example, the recording media include a floppy disk, a hard disk, an optical disk, a magneto-optical disk, magneto-optical disk (MO), a compact disc-read only memory (CD-ROM), a compact disc-recordable (CD-R), a compact disc-rewritable (CD-RW), a magnetic tape, a nonvolatile memory card, a read-only memory (ROM), a digital versatile disc (DVD) (digital versatile disc-read only memory (DVD-ROM), digital versatile disc-recordable (DVD-R)), or the like.

In addition, as a method of providing a program, a program can be provided by connecting to a web page of the Internet using a browser of a client computer and downloading the program from the web page to a recording medium, such as a hard disk. In such a case, the downloaded program can be a computer program itself of the present invention or a file which is compressed and includes an automatic installation function. The program can be realized by dividing program code including the program of the present invention into a plurality of files and downloading each file from different web pages. That is, the present invention also includes a World Wide Web (WWW) server, which allows a plurality of users to download the program file for realizing the processing of the functions of the exemplary embodiments by a computer.

Further, a method can be employed to encrypt a program of the present invention, to store it on a storage medium, such as a compact disc read only memory (CD-ROM), and to distribute it to users. In such a case, the encrypted program is installed on computers in executable formats by allowing users who satisfy a predetermined condition to download key information to decrypt the encrypted program from a web page via the Internet.

Furthermore, the functions of the exemplary embodiments can also be realized in a form other than the form which realizes the functions of the above-described exemplary embodiments by running the program read by a computer. For example, the functions of the above-described exemplary embodiments can also be realized by processing in which an operating system (OS) or the like running on a computer performs a part or the whole of actual processing based on an instruction of the program.

Further, a program read from a recording medium can be written in a memory included in a function expansion board inserted into a computer or a function expansion unit connected to a computer. In this case, the functions of the above-described exemplary embodiments can be realized by processing in which a central processing unit (CPU) or the like included in the function expansion board or function expansion unit performs a part or the whole of actual processing based on an instruction of the program.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2006-324696 filed Nov. 30, 2006, which is hereby incorporated by reference herein in its entirety.

1. A management apparatus comprising:
a first determination unit configured to determine whether or not another management apparatus exists on a network;
a first acquisition unit configured to acquire information on a device searched by the another management apparatus from the another management apparatus, in a case that it is determined by said first determination unit that the another management apparatus exists on the network;
a search unit configured to search for a device on the network;
a second determination unit configured to determine whether or not the device searched by said search unit is searched by the another management apparatus based on information on the device searched by said search unit and the information acquired by said first acquisition unit; and
a second acquisition unit configured to acquire information from the device, that is not acquired by said search unit from among information on the device searched by said search unit, in a case that it is not determined by said second determination unit that the device searched by said search unit is searched by the another management apparatus.

2. The management apparatus according to claim 1, wherein said search unit is configured to acquire information including at least one of an Internet Protocol (IP) address, a Universally Unique Identifier (UUID), a serial number of the device, and a media access control (MAC) address from the device searched for.

3. The management apparatus according to claim 1, further comprising a notification unit configured to notify the another management apparatus of the information acquired by said second acquisition unit, in a case that it is determined by said first determination unit that the another management apparatus exists on the network.

4. The management apparatus according to claim 1, wherein said second acquisition unit is configured to acquire information including at least one of a model name of the device, function information of the device, and a status of the device from the device searched for.

5. The management apparatus according to claim 1, further comprising a reacquisition unit configured to reacquire information indicating a status of the device, in a case that the information acquired by said second acquisition unit includes the information indicating the status.

6. The management apparatus according to claim 1, further comprising a reservation unit configured to notify the another management apparatus of a device from which information is to be acquired by said second acquisition unit before said second acquisition unit acquires the information and to inhibit the another management apparatus from acquiring information on the device.

7. The management apparatus according to claim 6, wherein an effective period of said reservation unit is predetermined.

8. A method of managing a device on a network, comprising:
judging whether or not another management apparatus exists on the network;
acquiring information on a device searched by the another management apparatus from the another management apparatus, in a case that it is judged in said judging step that the another management apparatus exists on the network;
searching for a device on the network:
determining whether or not the device searched in said searching step is searched by the another management apparatus, based on information on the device searched in said searching step and the information acquired in said acquiring step; and
obtaining information from the device, that is not acquired in said searching step from among information on the device, in a case that it is not determined in said determining step that the device searched in said searching step is searched by the another management apparatus.

9. The method according to claim 8, wherein the information acquired in said searching step includes at least one of an Internet Protocol (IP) address, a Universally Unique Identifier (UUID), a serial number of the device, and a media access control (MAC) address.

10. The method according to claim 8, wherein the information acquired in said acquiring step includes at least one of a model name of the device, function information of the device, and a status of the device.

11. The method according to claim 8, further comprising the step of notifying the another management apparatus of the information acquired from the device, in a case that it is determined in said judging step that the another management apparatus exists on the network.

12. The method according to claim 8, further comprising the step of reacquiring information indicating a status of the device, in a case that the information obtained from the device in said obtaining step includes the information indicating the status.

13. The method according to claim 8, further comprising the step of notifying the another management apparatus of a device from which information is to be obtained in said obtaining step, before obtaining the information from the device in said obtaining step, and inhibiting the another management apparatus from acquiring information on the device.

14. The method according to claim 13, wherein an effective period of said inhibiting step is predetermined.

15. A computer-readable storage medium storing program for causing a computer to execute the process comprising the steps of:
judging whether or not another management apparatus exists on a network;
acquiring information on a device searched by the another management apparatus from the another management apparatus, in a case that it is judged in said judging step that the another management apparatus exists on the network;
searching for a device on the network:
determining whether or not the device is searched by the another management apparatus based on information on the device searched in said searching step and the information acquired in said acquiring step; and
obtaining information from a device, that is not acquired in said searching step among information on the device, in a case that it is determined in said determining step that the device searched in said searching step is not searched by the another management apparatus.
